(19) United States
(12) Patent Application Publication
(10) Pub. No.: US 2005/0169720 A1
(43) Pub. Date: Aug. 4, 2005

(54) Woodwork drill bit

(75) Inventor: Hiroshi Kobayashi, Miki-shi (JP)

Correspondence Address: KODA & ANDROLIA, 2029 CENTURY PARK EAST, SUITE 1140, LOS ANGELES, CA, 90067, US

(73) Assignee: Kobayashi Gimlet Mfg. Co., Ltd.

(21) Appl. No.: 10/769,112

(22) Filed: Jan. 30, 2004

(51) Int. Cl. B23B 51/00

(52) U.S. Cl. 408/214

(57) ABSTRACT

A woodwork drill having a drill bit 1 equipped with a tip screw 3 at the center of its tip, wherein three spiral leads 2 are formed on the drill bit 1, and raked blades 4 are respectively formed at the tips of the three spiral leads from the periphery toward the center. At the peripheries of the tips of the three spiral leads, scribing blades 5 are formed in such a way that they stick out forward of the raked blades 4. The cutting resistances acting on the drill balance at three points, making it possible to drill an accurate hole without shaking the drill bit.

### BACKGROUND OF THE INVENTION

1. Field of the Invention

The present invention relates to a woodwork drill bit that fits mainly into an electric drill and is used for perforating boards and pillars.

2. Prior Art

A typical conventional woodwork drill bit described in the Japanese Patent Application Laid-Open (Kokai) No. 2002-21708 has a raked blade at the tip of a single spiral lead and a scribing blade that sticks out at the position opposite to the diameter direction of the raked blade. The applicant of the present invention has also developed a special woodwork drill bit to be used with a mechanical feeding means as described in the Japanese Utility Model Application Laid-Open (Kokai) No. H6-50162. This drill bit has two leads formed on it, and a cutting blade is established at the tip of each lead.

Using a conventional woodwork drill bit having a single spiral lead with a raked blade and a scribing blade at its tip, it is difficult to bore an accurate hole when, for example, using it with an electric drill to perform a perforating operation. In such a conventional drill bit, because a cutting resistance acts primarily on one side of the rotation center, the drill easily deviates from the correct advancing direction. Moreover, because of the deviation of the drilling course, the shape of the drilled hole tends to be deformed rather than a perfect circle. This tendency remains even when using a drill bit having two leads, in which case cutting resistances balance in the direction that raked blades face each other, but shaking occurs in other orientations. Even with a drill bit having two leads, it is difficult to machine an accurate hole.

### SUMMARY OF THE INVENTION

The objective of the present invention is to provide a woodwork drill bit that solves the problems attached with the conventional techniques and is capable of boring accurate holes consistently.

In order to achieve the above objective, the present invention constitutes three spiral leads 2 on a drill bit 1 and a tip screw 3 or a center positioning auger at the center of the tip of the drill bit 1 in such a way that the tip screw or the center auger sticks out from the tip of the drill bit. At the tip of each of the three spiral leads 2, a raked blade 4 is formed from the periphery toward the center. On the tip periphery of each of the three spiral leads 2, a scribing blade 5 is formed in such a way that it sticks out forward of the raked blade 4.

Thanks to the above constitution, when the worker pushes in the drill with the center auger pointing at the right position, or when the drill bit 1 is pulled into the work piece by the tip screw 3, the three scribing blades 5 formed at the tips of the three spiral leads 2 perform scribing for a hole simultaneously. When the drill bit 1 is further pulled in or pushed in, the three raked blades 4 cut the inside of the scribed circle simultaneously, further proceeding with the perforation. Cutting resistances by the raked blades 4 and scribing blades 5, which are both located at three positions, act on the rotating drill bit 1, so the perforation continues in a balanced condition. As a result, it is possible to avoid the shaking of the drill bit or the deviation of the drilling direction which otherwise might have been caused by the cutting resistances. This means a hole with a beautifully machined surface can be obtained because the drill bit does not shake, therefore the internal surface of the bored hole is not plucked by the leads.

### BRIEF DESCRIPTION OF THE DRAWINGS

FIG. 1 is a front view of a woodwork drill bit of the present invention;

FIG. 2 is an enlarged bottom view of the woodwork drill bit shown in FIG. 1;

FIG. 3 is a perspective view of the tip of the woodwork drill bit shown in FIG. 1;

FIG. 4 is a development view of the outer surface of the tip of the woodwork drill bit shown in FIG. 1; and

FIG. 5 is a perspective view of the tip of a woodwork drill bit according to another embodiment.

### DETAILED DESCRIPTION OF THE INVENTION

The embodiments of the woodwork drill bit according to the present invention will now be explained by reference to the accompanying drawings.

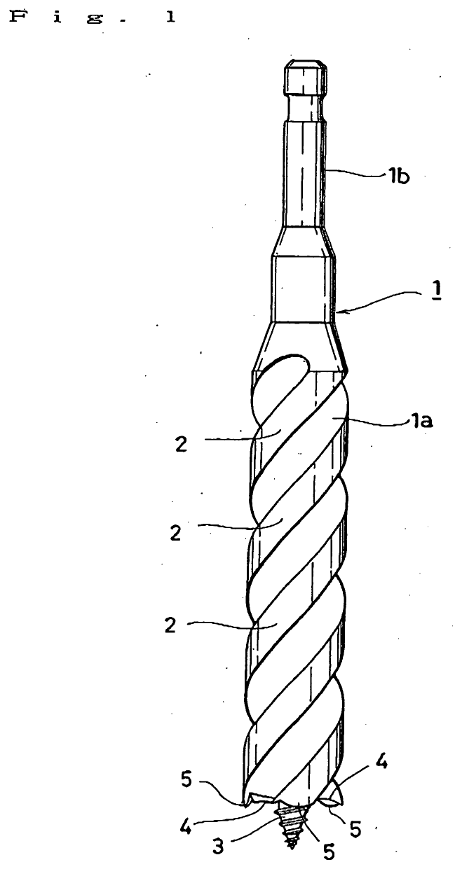

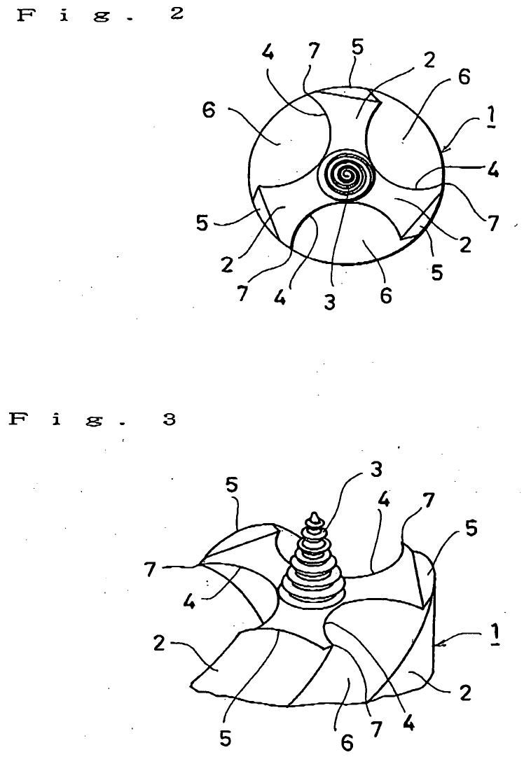

FIG. 1 is a front view of a woodwork drill bit according to the present invention. FIG. 2 is an enlarged bottom view of the woodwork drill bit shown in FIG. 1.

Drill bit 1 comprises a main part 1a, on which three spiral leads 2 are formed, and a chuck shaft 1b, which is integrated to the upper end of the main part 1a. A tip screw 3 is provided at the center of the tip of the drill bit 1, and at the tip of each of the three spiral leads a raked blade 4 is formed from the periphery toward the center. On the periphery of each of the three spiral leads 2, a scribing blade 5 is formed in such a way that it sticks out forward of the raked blade 4.

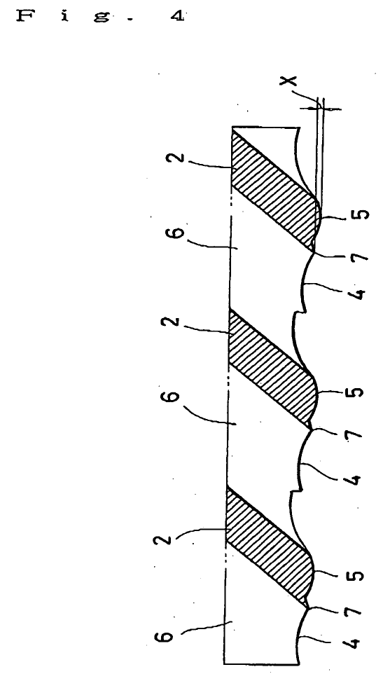

As shown in FIGS. 2 and 3, the tip screw 3 is formed at the center of the drill bit 1, and a raked blade 4 and a scribing blade 5 are formed at the tip of each of the three spiral leads 2. The three spiral leads 2 form discharge grooves 6 between them. A blade point 7 is formed at the tip periphery as well as at the tip of the rotary direction of each of the spiral leads, i.e., at the outer end of the raked blade 4.

As a variant of the woodwork drill bit having a tip screw 3 at its tip, there is a woodwork drill bit having a center auger 2 as shown in FIG. 5, for the main purpose of positioning the drill. The present invention can also be applied in this type of woodwork drill. Using a woodwork drill having a center auger 3 as shown in FIG. 5, the worker needs to keep on pushing the drill as the perforation proceeds, but the drill is not pulled in more than it is necessary. The user can choose whichever is more appropriate for the purpose.

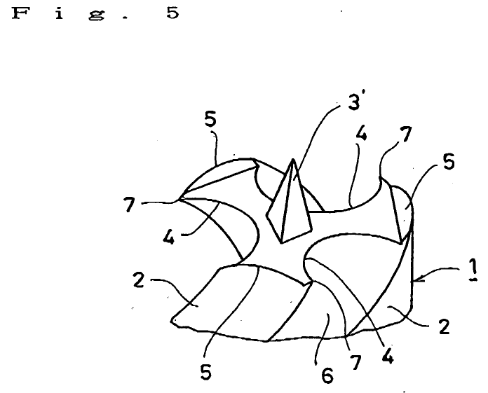

FIG. 4 is a development view showing only the tip of the woodwork drill bit shown in FIG. 1. Hatching is provided on the periphery of the spiral leads. A blade point 7 is formed at the left end of each spiral lead 2. Immediately behind the blade point 7, a sharp cutting blade, i.e., a scribing blade 5 is formed along the periphery in such a way that it sticks out to form a convex arc. The projection X of the scribing blade 5 needs not be so large, but it sticks out at least more forward of the blade point 7. Aside from the scribing blade 5, a raked blade 4 is formed in the discharge groove 6 from the blade point 7 toward the center.

To perform a perforating operation using the woodwork drill of the present invention of the above constitution, the tip of the tip screw 3 is pushed against the center of the position where the hole is to be made. When the drill bit 1 is rotated, the drill bit 1 is pulled into the work piece. As the drill bit 1 is pulled into the work piece, first the three scribing blades 5 contact the work piece and form a circular cut. Then the three raked blades 4 extending from the blade points 7 inward contact the surface of the work piece and continue cutting the inside of the circular cut made by the scribing blades 5. The chips produced by the raked blades 4 move along the discharge grooves 6 and are discharged outside from the opening of the hole that is being made.

In the above drilling process, the first circular cut is made by the scribing blades 5, which are arranged on the outermost periphery of the drill bit 1 at equal intervals. Because of this arrangement, the cutting resistances balance overall, without generating a force that may deviate the advancing direction of the drill bit 1, which continues drilling an accurate circular hole. Inside the cut, the three raked blades 4 continue cutting the work piece simultaneously, balancing the cutting resistances overall and continuing the perforation without causing the drill bit 1 to shake horizontally.

In the cutting process by the raked blades 4, the blade points 7 continue cutting along the circular cut made by the scribing blades 5, and the raked blades 4 continue cutting the inside, without causing the drill bit 1 to shake, resulting in a drilled hole with a clean surface inside. In this way, the deviation of the drilling direction can be minimized, making it possible to drill a straight and accurate hole. The cutting amount of each raked blade 4 of the present invention is one third of that of the conventional woodwork drill that cuts with a single raked blade. Accordingly, the cutting resistance acting on each of the raked blades 4 is smaller, making it possible to proceed drilling more consistently with a lighter force.

According to the woodwork drill bit of the present invention, the cutting resistances of the scribing blades and raked blades act on the tips of the three spiral leads of the drill bit respectively, realizing a balanced rotation of the drill bit without causing it to shake horizontally. As a result, it is possible to drill a straight and accurate hole. This means no extra forces act on the drill bit, and the perforation operation can be performed with a light and consistent force.

According to the present invention, the sharp blade points move along a circular cut scribed by the scribing blades, and the raked blades that continue from the blade points proceed with the drilling. As a result, it is possible to drill a hole with a cleaner finish of the interior surface.

1. A woodwork drill bit equipped with a tip screw or a center auger at the center of its tip, wherein three spiral leads are formed on the bit, a raked blade is formed at the tip of each of the three spiral leads from the periphery toward the center, and a scribing blade is formed on the tip periphery of each of the three spiral leads in such a way that it sticks out forward of the raked blade.

2. A woodwork drill bit as described in claim 1, wherein a sharp blade point is formed at the forward tip of the tip periphery of each of the three spiral leads, and the raked blade extends from the blade point toward the center of the bit.
